(19) United States
(12) Patent Application Publication
(10) Pub. No.: US 2007/0185936 A1
(43) Pub. Date: Aug. 9, 2007

(54) Managing deletions in backup sets

(76) Inventors: David George Derk, Gibsonia, PA (US); Ken E. Hannigan, Tucson, AZ (US); Avishai Haim Hochberg, San Jose, CA (US); Thomas Franklin Ramke JR., Vonore, TN (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/349,845

(22) Filed: Feb. 7, 2006

(51) Int. Cl. G06F 17/30

(52) U.S. Cl. 707/204

(57) ABSTRACT

Provided are a method, system, and article of manufacture, wherein image data corresponding to data stored in a storage unit is stored in a backup set. Metadata that indicates deletions made to files and directories in the storage unit is stored in the backup set, subsequent to the storing of the image data in the backup set. Additions and modifications made to the files and the directories in the storage unit are stored in the backup set, subsequent to the storing of the metadata in the backup set. The data stored in the storage unit is recovered from the backup set.

### BACKGROUND

1. Field

The disclosure relates to a method, system, and article of manufacture for managing deletions in backup sets.

2. Background

Data stored in a disk coupled to a computer can be backed up by generating an image of the disk. The image of the disk may be generated by copying the disk block by block. Such types of backups may be referred to as image backups. Data stored in a disk can also be backed up by copying the individual files and directories on the disk. Such types of backups may be referred to as “file level” backups.

When backing up an entire disk, there may be a performance advantage to generating an image backup instead of a file level backup. Image backups, however, do not offer the fine granularity that file level backups offer. For example, file level backups may be used to incrementally back up only those files and directories that were changed or created since the last backup. Similarly while restoring an entire disk, it is usually quicker to do so from an image backup, but file level backups allow the selection of the files and directories to be restored without having to restore the entire disk.

Certain data centers may perform both image and file level backups of disks, where image backups are used to quickly restore the entire disk in the event of a failure of the disk, and file level backups are used to restore a subset of the files and directories of the failed disk. Because image backups need the backing up of the entire disk, image backups are usually performed less frequently than incremental file level backups. Certain data centers may generate an image backup once a week, or once a month, and then back up new and changed files once a day. In such data centers, if a disk is lost, the most recent image backup could be restored, and then the incremental file level backups could be used to restore those files or directories that are needed to bring the data up to date.

Once the data of a computer is backed up, storage administrators may have the option of copying the backups into a “backup set.” Backup sets may include copies of the most recently backed up versions of the files and directories of a computer or storage unit. Backup sets may be stored on a set of removable media such as tape or optical disk. Backup sets may be used for long term archival copies of critical business data, for off-site copies of backup data used for disaster recovery, for portable backup copies that can be restored directly on the local computer without the need for a remote storage management server, and for point in time snapshots of the state of the files of a computer or a storage unit.

Backup sets can include backed up disk images or backed up files and directories. Image backup sets may be used in the same way the image backups themselves are used and may be used to provide timely restore of a disk in the event of a disk failure or other disaster. File level backup sets can also be used in this way, since file level backup sets represent a point in time snapshot of the files on the disk of a computer. File level backup sets additionally offer the ability to select the individual files or directories to be restored, which makes file level backups useful for long term archiving of data.

### SUMMARY OF THE DESCRIBED EMBODIMENTS

Provided are a method, system, and article of manufacture, wherein image data corresponding to data stored in a storage unit is stored in a backup set. Metadata that indicates deletions made to files and directories in the storage unit is stored in the backup set, subsequent to the storing of the image data in the backup set. Additions and modifications made to the files and the directories in the storage unit are stored in the backup set, subsequent to the storing of the metadata in the backup set. The data stored in the storage unit is recovered from the backup set.

In certain additional embodiments, recovering the data stored in the storage unit from the backup set comprises restoring the image data, and determining from the metadata those files and directories that are to be deleted in the restored image data. Subsequently, the determined files and directories are deleted from the restored image data. The additions and the modifications made to the files and the directories are restored, in response to deleting from the restored image data the determined files and directories.

In still additional embodiments, wherein the determined files and directories are deleted subsequent to the restoring of the image data but prior to the restoring of the additions and the modifications, wherein the deleting of the determined files and directories from the restored image data further comprises deleting the determined files, and deleting the determined directories, wherein lower level directories are deleted before higher level directories, and wherein a directory is not deleted until all files in the directory have been deleted.

In further embodiments, for recovering the data in the storage unit from the backup set, operations that result in a reduction in space requirements during the recovering of the data are performed before operations that cause an expansion in the space requirements during the recovering of the data, wherein the metadata is stored only in the backup set, and wherein the backup set includes all information necessary for recovering the data in the storage unit.

In still further embodiments, a plurality of backup sets that have been created at different times includes the same image data but includes different additions and modifications, and includes different metadata.

### BRIEF DESCRIPTION OF THE DRAWINGS

Referring now to the drawings in which like reference numbers represent corresponding parts throughout:

FIG. 1 illustrates a block diagram of a computing environment in accordance with certain embodiments;

FIG. 2 illustrates operations for creating backup sets at different times with the same image data, in accordance with certain embodiments;

FIG. 3 illustrates operations for creating a backup set that includes image data, metadata that includes deletions made to files and directories, and additions and modifications made to the files and the directories, in accordance with certain embodiments;

FIG. 4 illustrates operations for recovering the data stored in the storage unit from the backup set, in accordance with certain embodiments;

FIG. 5 illustrates a block diagram that shows exemplary orders in which exemplary files and exemplary directories are deleted, in accordance with certain embodiments; and

FIG. 6 illustrates the architecture of computing system, wherein in certain embodiments the computational platform of the computing environment of FIG. 1 may be implemented in accordance with the architecture of the computing system.

### DETAILED DESCRIPTION

In the following description, reference is made to the accompanying drawings which form a part hereof and which illustrate several embodiments. It is understood that other embodiments may be utilized and structural and operational changes may be made.

### Image Level Backups and File Level Backups

Image backup sets are a snapshot of a source storage unit, such as a disk, taken at a particular point in time. Since image backup sets are usually created relatively infrequently (e.g., weekly or monthly), it is generally not possible to use an image backup set to bring a disk up to date. A first solution may be to restore the disk to the point in time represented by the image backup set, and then restore the incremental file level backups of whatever files or directories are needed to bring the disk up to date. However, in certain types of disasters, the backup server storing the incremental file level backups may not be available, making such the first solution infeasible. A second solution may be to store a copy of the most recent file level backup set along with each image backup set. While this resolves the problems caused by the first solution, because the file level backup set includes the most recently backed up versions of all of the backed up files of a computer, it may take a relatively long time to search the backup set for just those files and directories that were backed up after the image.

Additionally, because the file level backup set may be created without knowledge of the image backup set that corresponds to the file level backup, the file level backup set may not have a record of files that might have been deleted from a source storage unit after the image backup set was created. Determining which files should be deleted may result in a time consuming process of comparing the contents of the file level backup set with that of the disk. The alternative of leaving the deleted files in place, however, not only runs the risk of running out of space on the disk, but may leave the disk in a state that may not match the pre-disaster condition of the disk

The first and second solutions use two complete sets of backups—a complete image backup of the disk, and a complete set of the most recently backed up versions of the files and directories on the disk. While the two complete sets of backups represent different point in time snapshots of the disk, the two complete sets of backups will usually contain many files that are the same.

File level backup sets are aggregates of the most recently backed up versions of all of the backed up files of a computer, and therefore file level backup sets can become quite large, and can take a long time to be generated. Since in many situations, only a small percentage of the files of a storage unit or a computer may change from day to day, backup sets created from one day to the next often contain a large number of identical files. Sometimes this is desirable, such as when a data center needs a self contained set of tapes to take off-site for disaster recovery. At other times, however, copying the same backup versions over and over again can become an onerous and time consuming.

### Managing Backup Sets

Certain embodiments allow the creation of “differential” backup sets. Differential backup sets include only the subset of files that were backed up after a “base” backup set is created. Even though differential backup sets include backed up versions of files and directories, differential backup sets may be based on either file level or image backup sets. Because a differential backup set only contains those versions of files that were backed up after the corresponding base was created, the differential backup set will typically be smaller than, and be generated more quickly than another full backup set created at the same time. Additionally, restoring a disk using an image and differential backup set together will take less time to bring the disk up to date than it would be to restore the image and the corresponding full file level backup set.

Certain embodiments, allow the inclusion of information about deleted files and directories that were deleted after the base image was stored, and allows differential backup sets to ensure that the data of a source storage unit is restored to the state the data in the source storage unit was in when the data was backed up. Including information about deleted files also helps ensure that a restoration process does not cause a file system to run out of space before the completion of the restoration process.

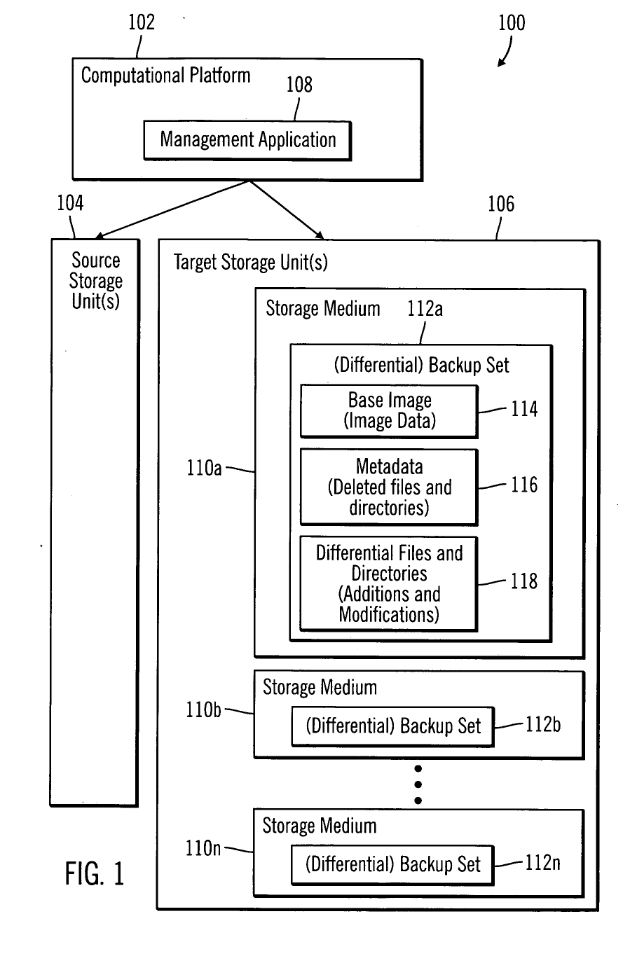

FIG. 1 illustrates a block diagram of a computing environment 100 in accordance with certain embodiments. In the computing environment 100, a computational platform 102 is coupled to at least one source storage unit 104 and at least one target storage unit 106. The computational platform 102, comprises any suitable computational device, including those presently known in the art, such as personal computers, workstations, mainframes, midrange computers, network appliances, palm top computers, telephony devices, blade computers, hand held computers, etc.

The source storage unit 104 and the target storage unit 106 include any suitable storage unit, including those presently known in the art, such as a disk drives, tape drives, optical drives, etc. In certain embodiments, where the computational platform 102 is a server, the source storage unit 104 may function as a client to the computational platform 102. The target storage unit 106 may be located inside or outside the computational platform 102. If the target storage unit 106 is located outside the computational platform 102, then in certain embodiments if the computational platform 102 is a server the target storage unit 106 may function as a client to the computational platform 102.

The coupling of the source storage unit 104 and the target storage unit 106 to the computational platform 102 may be via direct connections or may be over a network such as the Internet, a local area network, and storage area network, an Intranet, etc.

The computational platform 102 includes a management application 108 that copies data from the source target units 104 to the target storage units 106 at a plurality of different times. The management application108 may use the data copied to the target storage units 106 to recover the data stored in the source storage units 104 at those points in time at which the data was copied to the target storage units 106.

In certain embodiments, a plurality of storage media 110a, 110b, . . . , 110n may be coupled to the target storage unit 106, where a storage medium may include a tape, a disk, a DVD, a CD, or any other suitable storage medium. For example, the target storage unit 106 may be a tape drive, and the plurality of storage media 110a . . . . 110n may comprise tapes that may be read when inserted into the tape drive.

In certain embodiments each storage medium may include one or more backup sets. For example, in certain embodiments storage medium 110a may include the backup set 112a, storage medium 110b may include the backup set 112b, and storage medium 110n may include the backup set 112n.

A backup set, such as backup set 112a may include a base image 114, metadata 116 and differential files and directories 116. The backup set 112a may also be referred to as a differential backup set and the base image 114 may be referred to as image data.

The base image 114 is a snapshot, e.g., a block by block copy, of the data stored in the source target unit 104 taken at a particular point in time. In certain embodiments, the base image 114 may be created relatively infrequently (e.g., weekly or monthly), and it may not be possible to use the base image 114 only to recover the data stored in the source target unit 104, because additions, modifications, and deletions may have occurred to the data in the source storage unit 104 since the time the base image 114 was created.

The metadata 116 includes files and directories that have been deleted in the source storage unit 104 during the time interval between the creation of the base image 114 and the creation of the differential files and directories 118.

The differential files and directories 118 are based on the most recently created base image 114 and include additions and modifications to the files and directories stored in the base image 114. Over time, a plurality of differential files and directories may be created using the same base image. Each new differential files and directories may be larger than, and include more files than the previous differential files and directories.

In certain embodiments, at any given time the management application 108 may use the base image 114, in combination with the metadata 116, and the most recent differential files and directories 118 to restore the source storage unit 104 to the most recently backed up state.

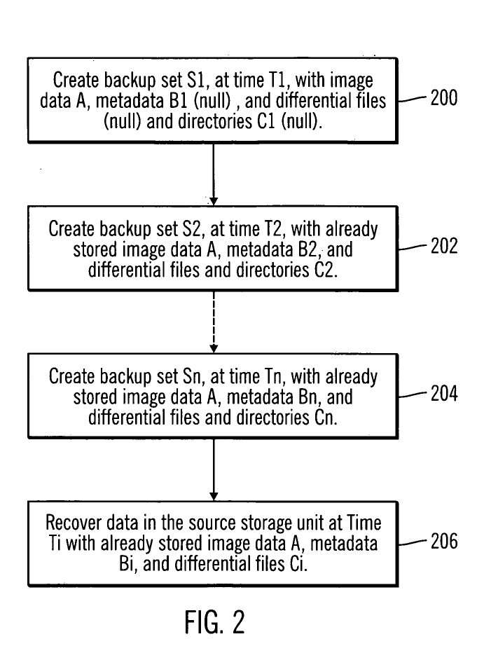

FIG. 2 illustrates operations for creating backup sets 112a . . . 112n at different times with the same image data, in accordance with certain embodiments. The operations illustrated in FIG. 2 may be implemented in the management application 108 that executes in the computational platform 102.

Control starts at block 200, where the management application 108 creates an exemplary backup set S1, at time T1, with image data A, metadata B1, and differential files and directories C1. For example, the management application 108 may create a backup set 112a at time T1, with image data, i.e., the base image, 114, metadata 116 and differential files and directories 118. If the image data A is being created for the first time, then metadata B1, and the differential files and directories Cl may be absent and may be assigned to be null.

After a certain period of time has elapsed since the creation of the backup set S1 at time T1, the management application 108 may at time T2 create (at block 202) an exemplary backup set S2, with already stored image data A, metadata B2, and differential files and directories C2. The image data A in the exemplary backup set S2 created at time T2 is the same as the image data A in the exemplary backup set S1 created at time T1. In certain embodiments, the image data A may be shared and stored in a common location accessible to the management application 108, and pointers to the common location may be stored in the exemplary backups sets S1 and S2 instead of storing the image data A.

Similarly, a plurality of backup sets may be created at different times. Control proceeds to block 204 where the management application 108 creates backup set Sn, at time Tn, with already stored image data A, metadata Bn, and differential files and directories Cn.

Therefore, blocks 202, 204, 206 indicate how a plurality of backup sets is created by the management application 108, where each backup set includes a common base image. In certain embodiments, the base image may also be updated at certain times. However, the base image 114 is updated less frequently than the differential files and directories 118.

In certain embodiments, backup versions of files and directories stored in the target storage unit 106 may be used by the management application 108 to create the backup sets 112a . . . 112n. Given two items of information about a backup version of a file or directory, the management application 108 can determine in a constant order of time whether the backup version meets the point in time criteria to be included in a backup set. The first item of information is the time when a particular backup version of a file or directory was backed up, and the second item of information is the time when a particular backup version of a file or directory was replaced by a newer version or was deactivated because the file or directory is no longer stored in the source storage unit 104. The first and second items of information allow the management application 108 to determine if a backup version is the active backup version at a given point in time.

Differential backup sets, as implemented in certain embodiments illustrated in FIGS. 1 and 2, include only the backup versions of the source storage unit's 104 files and directories that were active at a given point in time, and those files and directories that were backed up after the base image 114 was created. The point in time of the base backup image may be referred to as the “base date.” Given the base date and knowing when a file was backed up, the management application 108 can apply the following logic for choosing the backup versions to be included in a differential backup set, where for a given base date, a file or directory backed up before the base date is too old to be considered for inclusion in the differential backup set:

if“base date” < “backup time” AND

“backup_time” <= “point in time” AND

“point in time” < “deactivation time” THEN

Include file or directory in differential backup set

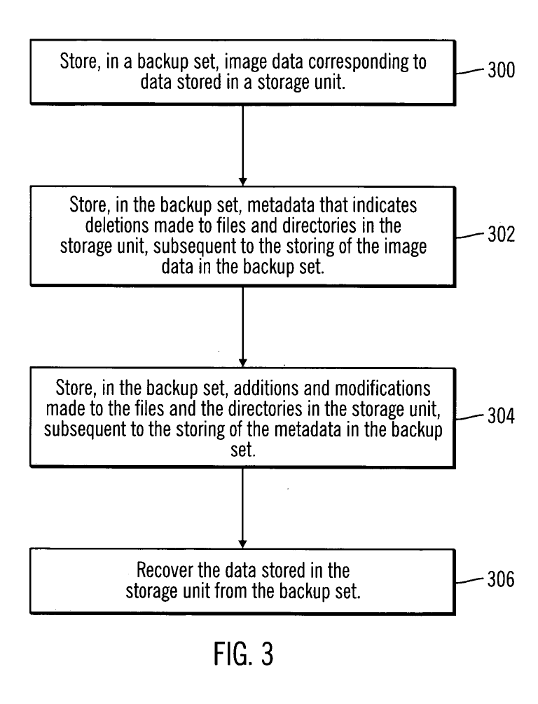

FIG. 3 illustrates operations for creating a backup set that includes image data, metadata that includes deletions made to files and directories, and additions and modifications made to the files and the directories, in accordance with certain embodiments. The operations illustrated in FIG. 3 may be implemented in the management application 108 that executes in the computational platform 102.

Before describing the operations described in FIG. 3, a discussion of problems that may arise in restoring data stored in the source storage unit 104 are described, in situations where the metadata 116 that includes files and directories that have been deleted is not maintained. When restoring a base image 114 and differential files and directories 118 without the metadata 116, a problem arises when dealing with files that were deleted after the base image 114 was generated. The base image 114 includes all files and directories at the point in time of the creation of the base image 114, and the differential files and directories 118 has the files and directories that were added or modified, but not deleted after the creation of the base image 114. Since a restoration may first restore the whole base image 114, when restoring the differential files and directories 118 on top of the base image 114 there is a possibility of over committing the filesystem, i.e., the space in the filesystem may get exhausted, because the deleted files have not been removed.

Certain embodiments do not require maintaining in a separate database a listing of the files and directories deleted in the interval between the creation of the base image 114 and the creation of the differential files and directories 118. However, if the metadata 116 is not used, when restoring a backup set 112, because there is no separate database of deleted files and directories to refer to, deleted files may not be removed from the filesystem where a restore operation to generate the data of the source storage unit 104 is taking place. This creates a situation where a filesystem could be over committed, causing the restore to fail.

Moreover, even if a restore succeeds without removing the deleted files, the result is not a true point in time image of the source storage unit 104 since there will be files in the restored data that had originally been removed. Therefore, certain embodiments for restoration stores metadata 116 that indicates the deleted files and directories. In this context, a deleted backup version is one which was active when the base backup set was created, but was subsequently deactivated because the file or directory was no longer stored in the source storage unit 104. Certain embodiments address these deleted backup versions so that a restoration can remove the files and directories from a filesystem before restoring the active versions.

In order to add deleted file information to a differential backup set, the management application 108 may determine for each backup version of a source storage unit's 104 files and directories whether the backup version is to be included in the backup set, by determining whether the backup version is still the active version or whether the backup version has been deactivated.

The management application 108 may first determine for a backup version of a file or directory whether the backup version of the file or directory was the active backup version of the file or directory when the base image was created. Then the management application 108 may determine if the backup version was deactivated before the differential backup set's point in time. If the backup version's deactivation date is less than the backup set's point in time, then the file or directory was deleted and needs to be marked as such in the metadata 116 of the backup set.

Therefore, the management application 108, may generate the metadata 116 that includes indicators for the deleted files according to the following logic:

if“backup time” <= “base date” AND

“base date” < “deactivation time” AND

“deactivation time” < “point in time” THEN
Include the file or directory in the metadata 116 of deleted

files/directories.

Certain embodiments allow the management application 108 to add information about deleted files and directories to the backup set 112a at the time the backup set 112a is generated, and to place the deleted files and directories in the backup set 112a in such a manner on the backup set 112a that no search of the media will be needed in order to restore the complete backup set.

In certain embodiments, data is placed in a backup set in the following order:
a) image data
b) deleted file entries
c) deleted directory entries
d) incremental (new and changed) files.

Proceeding now to the description of FIG. 3, control starts at block 300, where the management application 108 stores, in a backup set, such as the differential backup set 112a, image data 114 corresponding to data stored in a storage unit, such as the source storage unit 104. The image data 114 is the base image and may be copied block by block from the source storage unit 104 to the storage medium 110a in the target storage unit 106. In certain alternative embodiments, the backup set 112a may be generated from already stored backup versions of files and directories in the target storage unit 106.

The management application 108 stores (at block 302), in the backup set 112a, metadata 116 that indicates deletions made to files and directories in the source storage unit 104, subsequent to the storing of the image data 114 in the backup set 112a.

Control proceeds to block 304, where the management application 108 stores, in the backup set 112a, additions and modifications 118 made to the files and the directories in the source storage unit 104, subsequent to the storing of the metadata 116 in the backup set 112a.

The management application 108 may recover (at block 306) the data stored in the source storage unit 106 from the backup data set 112a stored in the target storage unit 108.

Therefore, FIG. 3 illustrates certain embodiments in which the management application stores a backup set 112a that includes a base image 114, metadata 116 that indicates deletions, and differential files and directories 118 that indicate additions and modifications.

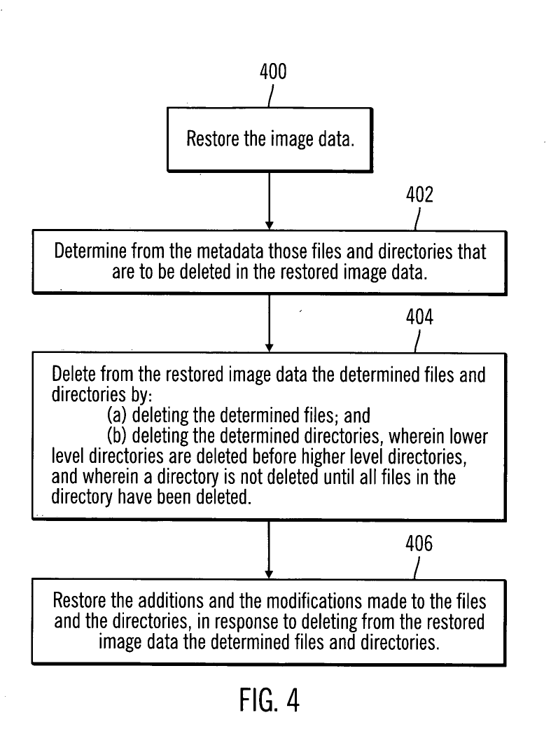

FIG. 4 illustrates operations for recovering the data stored in the storage unit from the backup set 112a, in accordance with certain embodiments. The operations illustrated in FIG. 4 may be implemented in the management application 108 that executes in the computational platform 102.

Control starts at block 400, where the management application 108 restores the image data 114, i.e., the base image 114 is restored first. The management application 108 determines (at block 402) from the metadata 116 those files and directories that are to be deleted in the restored image data.

The management application 108 deletes (at block 404) from the restored image data the determined files and directories by deleting the determined files, and deleting the determined directories, wherein lower level directories are deleted before higher level directories, and wherein a directory is not deleted until all files in the directory have been deleted.

The management application 108 restores (at block 406) the additions and the modifications 118 made to the files and the directories, in response to deleting from the restored image data the determined files and directories.

Using backup sets such as backup set 112a, the restore may accomplish the goal of creating a consistent and accurate point time image of the filesystem. Putting deleted files and directories 116 after the base image 114 but before the differential files and directories 118 in backup set allows the management application 108 to delete files and directories from the base image 114 before the management application 108 restores all other files and directories 118. Putting deleted directories after the deleted files ensures that the directories will be empty by the time the management application 108 needs to delete the directories. Certain embodiments provide the ability to retain any external database information regarding deletions beyond the time the deletion information is stored in the database. Additionally, certain embodiments also allow a local backup set 112 to restore without any dependency on an external database.

In certain embodiments the metadata 116 indicates the deleted file and directory entries. In certain embodiments in a current backup set stream that is being generated, before each file data a self describing “verb” may be inserted that holds all the relevant metadata for that file. After the metadata entry the binary stream of data for that file is stored. For deleted files only the metadata verb will be inserted into the stream, with a new type identifying this verb as describing a deleted file.

During restoration the stream is read sequentially. When a delete file or delete directory entry is encountered, the management application 108 removes that file or directory from the filesystem. By placing all the directory deletes after the file deletes, directories to be deleted will be empty (since all the files will have been removed) and the removal of the directory will not fail.

The sequence of execution described in FIG. 4 is the following:
a) Restore the image data to overwrite all the data on the volume. At this point, the volume will appear exactly as it did at the time of the image backup.
b) Remove all deleted files and directories that were valid at the time of the image backup but are no longer valid for the point in time of the incremental restore.
c) Finally, restore all the incremental files that were added or modified since the image backup to the point in time of the backup set generation.
   At this point, the current state of the filesystem is a true snapshot of the filesystem at the point in time equivalent to the time the backup set was generated.

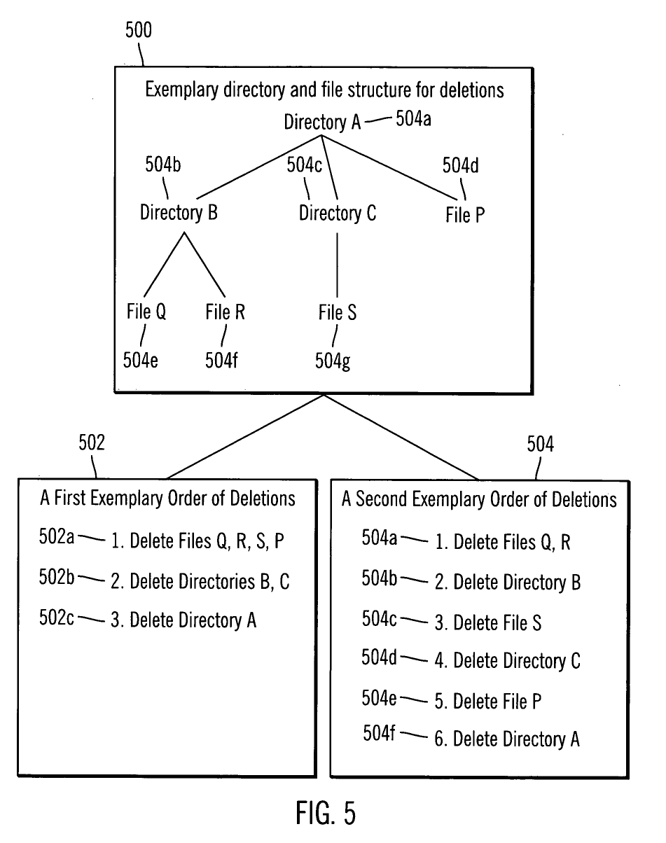

FIG. 5 illustrates a block diagram that shows exemplary orders in which exemplary files and exemplary directories are deleted, in accordance with certain embodiments.

An exemplary directory and file structure 500 for deletions is shown in FIG. 5. In the exemplary directory and file structure 500, a directory A 504a has two subdirectories directory B 504b and directory C 504c and a file P 504d. Directory B 504b includes file Q 504e and file R 504f, whereas directory C 504c includes file S 504g.

In a first exemplary order of deletions 502 the files Q 504e, R 504f, S 504g, P 504d are deleted first (reference numeral 502a). Then the directories B 504b and C 504c are deleted (reference numeral 502b). Subsequently, directory A 504a is deleted (reference numeral 502c).

In a second alternative exemplary order of deletions 504, first files Q 504e and R 504f are deleted (reference numeral 504a), then directory B 504b that included the files Q 504e and R 504f is deleted (reference numeral 504b). Then file S 504g is deleted (reference numeral 504c), and subsequently directory C 504c that included file S 504g is deleted (reference numeral 504d). Following this, file P 504d is deleted (reference numeral 504e) and then directory A 504 as deleted (reference numeral 504f).

Therefore FIG. 5 illustrates certain embodiments, wherein the deleting of the determined files and directories from the restored image data, comprises deleting the determined files and deleting the determined directories, wherein lower level directories are deleted before higher level directories, and wherein a directory is not deleted until all files in the directory have been deleted.

Certain embodiments use an image backup set with a file level differential backup set, to avoid the need to create and track multiple copies of the same data. Certain embodiments may use differential backup sets to create hybrid backup sets that allow the creation of up-to-date image backup sets without the expense of backing up a new image every day. It may be possible to create a hybrid backup set and a full file level backup set that provide the same point in time snapshot of a disk's contents. This, in turn, allows timely restore of an entire disk in the event of a disaster, and the ability to restore individual files and directories as needed. Furthermore, with two full backup sets—a hybrid and a file level backup set—that both contain the same point in time snapshot of a disk's contents, it becomes possible to generate a single differential backup set that can be used equally well with either full backup set.

In certain alternative embodiments, “delta” files and directories may be used instead of or in addition to the differential files and directories 118. While similar in many ways, differential and delta files and directories differ in the type of backup image used as the base. Delta files and directories are based on the most recently created backup set, be it a full backup set, or another delta backup set. The number of files contained in a given delta backup set is usually smaller than the number of files that would be in a differential backup set created at the same time, delta backup sets can be created more quickly than, and require less storage space than a differential backup set. However, over time, more delta backup sets are required in order to restore a disk to its most recently backed up state.

A backup version cannot be included in a backup set if it has been deleted. Furthermore, it is not possible to record information about deleted files if there is record that they ever existed. However, there are practical trade-offs involved. The more versions the system keeps, the more storage will be needed just for backup purposes. As such, keeping an unlimited number of versions is generally not feasible. Certain embodiments may therefore chose between the amount of time one is able to go back and the amount of storage available to hold backup versions. Systems that implement certain embodiments may provide tuning parameters to allow the administrator to make such a choice.

In certain additional embodiments, a retention time based policy rule specifies how long to retain file versions after deactivation. This value determines how far back the point in time can be from the time the backup set is generated, thereby creating a sliding window during which point-in-time backup sets can be generated. A number of inactive versions based policy rule specifies the maximum number of inactive backup versions to retain. This value can be set to a finite value to limit the number of versions and thereby limit the amount of storage required. Alternatively, this value can be set to infinite so the number of versions is unrestricted, and retention is managed solely by time. Backup versions may be automatically deleted based on policies for retention time or number of inactive versions, whichever occurs first.

### Additional Embodiment Details

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

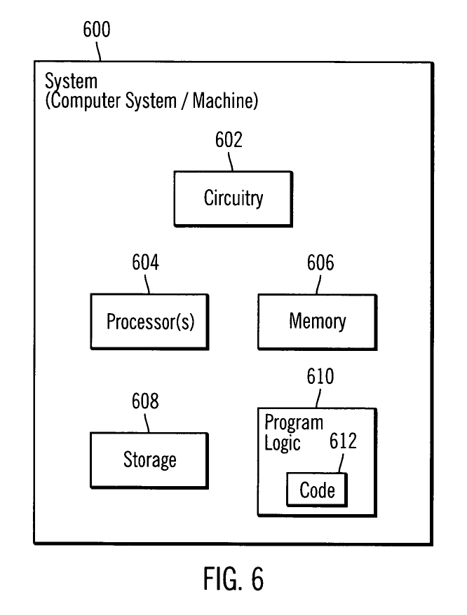

FIG. 6 illustrates an exemplary computer system 600, wherein in certain embodiments the computational platform 102 of the computing environment 100 of FIG. 1 may be implemented in accordance with the computer architecture of the computer system 600. The computer system 600 may also be referred to as a system, and may include a circuitry 602 that may in certain embodiments include a processor 604. The system 600 may also include a memory 606 (e.g., a volatile memory device), and storage 608. Certain elements of the system 600 may or may not be found in the computational platform 102. The storage 608 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 608 may comprise an internal storage device, an attached storage device and/or a network accessible storage device. The system 600 may include a program logic 610 including code 612 that may be loaded into the memory 606 and executed by the processor 604 or circuitry 602. In certain embodiments, the program logic 610 including code 612 may be stored in the storage 608. In certain other embodiments, the program logic 610 may be implemented in the circuitry 602. Therefore, while FIG. 6 shows the program logic 610 separately from the other elements, the program logic 610 may be implemented in the memory 606 and/or the circuitry 602.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in FIGS. 2, 3, 4 may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-6 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

What is claimed is:

1. A method, comprising:
storing, in a backup set, image data corresponding to data stored in a storage unit;
storing, in the backup set, metadata that indicates deletions made to files and directories in the storage unit, subsequent to the storing of the image data in the backup set; and
storing, in the backup set, additions and modifications made to the files and the directories in the storage unit, subsequent to the storing of the metadata in the backup set; and
recovering the data stored in the storage unit from the backup set.

2. The method of claim 1, wherein recovering the data stored in the storage unit from the backup set comprises:
restoring the image data;
determining from the metadata those files and directories that are to be deleted in the restored image data;
deleting from the restored image data the determined files and directories that are to be deleted; and
restoring the additions and the modifications made to the files and the directories in response to deleting from the restored image data the determined files and directories.

3. The method of claim 2, wherein the determined files and directories are deleted subsequent to the restoring of the image data but prior to the restoring of the additions and the modifications, and wherein the deleting of the determined files and directories from the restored image data further comprises:
deleting the determined files; and
deleting the determined directories, wherein lower level directories are deleted before higher level directories, and wherein a directory is not deleted until all files in the directory have been deleted.

4. The method of claim 1, wherein for recovering the data in the storage unit from the backup set, operations that result in a reduction in space requirements during the recovering of the data are performed before operations that cause an expansion in the space requirements during the recovering of the data, wherein the metadata is stored only in the backup set, and wherein the backup set includes all information necessary for recovering the data in the storage unit.

5. The method of claim 1, wherein a plurality of backups sets that have been created at different times include the same image data but includes different additions and modifications, and includes different metadata.

6. A system coupled to a storage unit, the system comprising: a memory; and
processor coupled to the memory, wherein the processor performs:
(i) storing, in a backup set, image data corresponding to data stored in the storage unit;
(ii) storing, in the backup set, metadata that indicates deletions made to files and directories in the storage unit, subsequent to the storing of the image data in the backup set; and
(iii) storing, in the backup set, additions and modifications made to the files and the directories in the storage unit, subsequent to the storing of the metadata in the backup set; and
(iv) recovering the data stored in the storage unit from the backup set.

7. The system of claim 6, wherein recovering the data stored in the storage unit from the backup set comprises:
restoring the image data;
determining from the metadata those files and directories that are to be deleted in the restored image data;
deleting from the restored image data the determined files and directories that are to be deleted; and
restoring the additions and the modifications made to the files and the directories in response to deleting from the restored image data the determined files and directories.

8. The system of claim 7, wherein the determined files and directories are deleted subsequent to the restoring of the image data but prior to the restoring of the additions and the modifications, and wherein the deleting of the determined files and directories from the restored image data further comprises:
deleting the determined files; and
deleting the determined directories, wherein lower level directories are deleted before higher level directories, and wherein a directory is not deleted until all files in the directory have been deleted.

9. The system of claim 6, wherein for recovering the data in the storage unit from the backup set, operations that result in a reduction in space requirements during the recovering of the data are performed before operations that cause an expansion in the space requirements during the recovering of the data, wherein the metadata is stored only in the backup set, and wherein the backup set includes all information necessary for recovering the data in the storage unit.

10. The system of claim 6, wherein a plurality of backups sets that have been created at different times includes the same image data but includes different additions and modifications, and includes different metadata.

11. An article of manufacture for controlling a storage unit, wherein the article of manufacture causes operations, the operations comprising:
storing, in a backup set, image data corresponding to data stored in the storage unit;
storing, in the backup set, metadata that indicates deletions made to files and directories in the storage unit, subsequent to the storing of the image data in the backup set; and
storing, in the backup set, additions and modifications made to the files and the directories in the storage unit, subsequent to the storing of the metadata in the backup set; and
recovering the data stored in the storage unit from the backup set.

12. The article of manufacture of claim 11, wherein recovering the data stored in the storage unit from the backup set comprises:
restoring the image data;
determining from the metadata those files and directories that are to be deleted in the restored image data;
deleting from the restored image data the determined files and directories that are to be deleted; and
restoring the additions and the modifications made to the files and the directories in response to deleting from the restored image data the determined files and directories.

13. The article of manufacture of claim 12, wherein the determined files and directories are deleted subsequent to the restoring of the image data but prior to the restoring of the additions and the modifications, and wherein the deleting of the determined files and directories from the restored image data further comprises:
deleting the determined files; and
deleting the determined directories, wherein lower level directories are deleted before higher level directories, and wherein a directory is not deleted until all files in the directory have been deleted.

14. The article of manufacture of claim I 1, wherein for recovering the data in the storage unit from the backup set, operations that result in a reduction in space requirements during the recovering of the data are performed before operations that cause an expansion in the space requirements during the recovering of the data, wherein the metadata is stored only in the backup set, and wherein the backup set includes all information necessary for recovering the data in the storage unit.

15. The article of manufacture of claim I 1, wherein the article of manufacture is a computer readable medium, and wherein a plurality of backups sets that have been created at different times includes the same image data but includes different additions and modifications, and includes different metadata.

16. A method for deploying computing infrastructure, comprising integrating computer-readable code into a computing system, wherein the code in combination with the computing system is capable of performing:
storing, in a backup set, image data corresponding to data stored in a storage unit;
storing, in the backup set, metadata that indicates deletions made to files and directories in the storage unit, subsequent to the storing of the image data in the backup set; and
storing, in the backup set, additions and modifications made to the files and the directories in the storage unit, subsequent to the storing of the metadata in the backup set; and
recovering the data stored in the storage unit from the backup set.

17. The method for deploying computing infrastructure of claim 16, wherein recovering the data stored in the storage unit from the backup set comprises:
restoring the image data;
determining from the metadata those files and directories that are to be deleted in the restored image data;
deleting from the restored image data the determined files and directories that are to be deleted; and
restoring the additions and the modifications made to the files and the directories in response to deleting from the restored image data the determined files and directories.

18. The method for deploying computing infrastructure of claim 17, wherein the determined files and directories are deleted subsequent to the restoring of the image data but prior to the restoring of the additions and the modifications, and wherein the deleting of the determined files and directories from the restored image data further comprises:
deleting the determined files; and
deleting the determined directories, wherein lower level directories are deleted before higher level directories, and wherein a directory is not deleted until all files in the directory have been deleted.

19. The method for deploying computing infrastructure of claim 16, wherein for recovering the data in the storage unit from the backup set, operations that result in a reduction in space requirements during the recovering of the data are performed before operations that cause an expansion in the space requirements during the recovering of the data, wherein the metadata is stored only in the backup set, and wherein the backup set includes all information necessary for recovering the data in the storage unit.

20. The method for deploying computing infrastructure of claim 16, wherein a plurality of backups sets that have been created at different times includes the same image data but includes different additions and modifications, and includes different metadata.
